(19) United States
(12) Patent Application Publication
(10) Pub. No.: US 2004/0010800 A1
(43) Pub. Date: Jan. 15, 2004

(54) Digital video jukebox network enterprise system

(76) Inventor: John Goci, Westland, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/135,218

(22) Filed: Apr. 29, 2002

(51) Int. Cl. H04N 7/173; G06F 3/00; H04N 5/445; H04N 5/64; H04N 9/31; G06F 13/00; H04N 7/18

(52) U.S. Cl. 725/78; 725/82; 725/87; 725/61; 725/60; 348/744

(57) ABSTRACT

An integrated video jukebox and entertainment management system for a premises comprises a video jukebox server providing a set of video selections customized to a predetermined commercial enterprise for the premises. A large-area display system is deployed in the premises. A plurality of jukebox clients are deployed in the premises and networked with the jukebox server. A payment acceptor is coupled to at least one of the jukebox clients for establishing credits for accessing the video selections. A touch screen input device is coupled to the one jukebox client for providing a user interface wherein a user is able to browse the set of video selections and choose a desired video selection for display by the large-area display system. The one jukebox client transmits a request to the jukebox server for displaying the desired video selection if sufficient credits are established.

### BACKGROUND OF THE INVENTION

The present invention relates in general to a digital video jukebox system, and, more specifically, to integrating a video jukebox system with a commercial enterprise to increase customer enjoyment of video services while reducing operating costs of the commercial enterprise.

Jukeboxes in commercial establishments for playing selected audio recordings are widespread, but have become less numerous in recent years. During the same time period, combined audio and video (multimedia) content has increased in popularity, e.g., music videos. While the rise in music videos was originally associated with cable television, the Internet has also become an important distribution channel of music videos and as well as other multimedia content such as movies and live broadcasting.

Computer kiosks are being deployed in public places such as airports for allowing persons to access Internet applications (e.g., e-mail and web browsing). The kiosks provide a self-contained computer system such that a user can obtain a private network session. Typically, the user may be charged a fee to use the computer kiosk. Although most current uses of these systems relate to business applications (e.g. mobile office), entertainment and other applications are available through web browsing. Kiosk use for entertainment applications has been limited by cost, availability, and convenience.

Public restaurants, taverns, nightclubs, or other commercial enterprises often provide audio or multimedia entertainment within their establishment, which may be recorded, live, or a combination of the two (e.g., karaoke or live DJ's). Video systems often include large projection screens and/or television monitors for presenting sports coverage or music videos, for example. The same projection and sound reproduction equipment may be used for prerecorded, live broadcast, and live performer entertainment, but the organization, control, and delivery of an overall entertainment experience has been difficult and costly to manage.

### SUMMARY OF THE INVENTION

The present invention provides a video entertainment system integrated with a commercial enterprise, resulting in advantages of lower overall cost to the business enterprise, increased customer satisfaction, and increased revenues.

In one aspect of the invention, an integrated video jukebox and entertainment management system for a premises comprises a video jukebox server providing a set of video selections customized to a predetermined commercial enterprise for the premises. A large-area display system is deployed in the premises. A plurality of jukebox clients are deployed in the premises and networked with the jukebox server. A payment acceptor is coupled to one of the jukebox clients for establishing credits for accessing the video selections. A touch screen input device is coupled to the one jukebox client for providing a user interface wherein a user is able to browse the set of video selections and choose a desired video selection for display by the large-area display system. The one jukebox client transmits a request to the jukebox server for displaying the desired video selection if sufficient credits are established.

### BRIEF DESCRIPTION OF THE DRAWINGS

FIG. 1 is a block diagram showing the digital video jukebox network deployed in a premises.

FIG. 2 is a flowchart showing a method of operating the jukebox network of FIG. 1.

FIG. 3 is a flowchart showing a method for identifying selections within a video jukebox server.

FIG. 4 is a front view of a first screen of a touch screen user interface for a video jukebox client.

FIG. 5 is a front view of a second screen of a touch screen user interface for a video jukebox client.

FIG. 6 is a block diagram showing a video jukebox server in greater detail.

FIG. 7 is a block diagram showing a video jukebox client in greater detail.

### DETAILED DESCRIPTION OF PREFERRED EMBODIMENTS

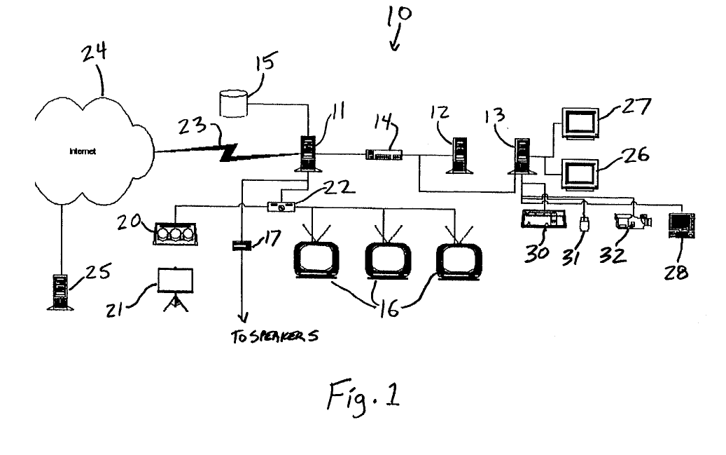

Referring to FIG. 1, a digital video jukebox network 10 is organized in a server-client architecture including a jukebox server 11 and one or more jukebox clients. Two jukebox clients 12 and 13 are shown, but any desired number of clients can be deployed within the premises serviced by network 10 in order to make the jukebox network available to customers of the commercial enterprise (e.g., a client at each table in a nightclub). An Ethernet hub 14 connects server 11 to clients 12 and 13.

Jukebox server 11 may be coupled to several sources of multimedia content including, for example, a removable hard drive 15. The multimedia content may include digital video selections (e.g., music videos, movies, movie trailers, advertisements, announcements, or any other customized audio-visual material desired by the commercial enterprise) and digital audio (e.g., music without accompanying video). The multimedia content may preferably be stored in a compressed format as is known in the art. By providing the multimedia content on removable hard drives, a jukebox service provider can customize and easily update the multimedia content offered at the premises by swapping out the hard drive. By storing on the hard drive the data of the number of times selections have been played, retrieval of information on the fees due to be paid by the commercial enterprise to the jukebox service provider is also simplified.

Multimedia content from hard drive 15 is retrieved and decoded by jukebox server 11 and then reproduced by a large area display for entertainment of the patrons of the commercial enterprise. The display may include a plurality of television monitors 16, a sound reproduction system 17, a CRT projector 20, and a projection screen 21. If necessary for reformatting of the decoded digital video signals (e.g., into an NTSC format), a reformatting device such as a VCR 22 may be connected between jukebox server 11 and the display devices.

Audio processing may be done internally in server 11 or may be done in an external sound card 18 (e.g., the Sound Blaster Extigy from Creative Labs, Inc.). A wireless remote control 19 is used to adjust audio parameters (e.g., volume and input source). So that sound reproduction system 17 can be used as a public address system and for performing karaoke, a microphone 33 is connected to sound card 18.

In the event of a media failure or communication failure preventing reproduction of video content, an audio player 34 such as an MP3 player is connected to sound card 18 which can be manually activated when needed. Predetermined audio selections are loaded into player 34 and can be manually selected via its separate interface. In one embodiment, server 11 monitors the most popular video selections requested by customers and downloads corresponding audio files into player 34 so that an appropriate mix of audio selections are available during any potential failure of the video system.

Jukebox server 11 may also receive multimedia content via a network connection 23 (e.g., DSL, dial-up modem, cable modem, or T-1 line) to Internet 24. For example, a video jukebox master server 25 is accessible via Internet 24 for providing downloads of multimedia content as well providing supervisory access by the jukebox service provider. The Internet connection can also be used to provide web browsing activities to users of the jukebox clients, if desired.

The present invention provides flexibility in arranging each jukebox client station with interfaces and peripheral devices matched to the intended use by customers and/or employees of the commercial enterprise. At a first station, for example, jukebox client 13 is connected to a touch screen input device 26. Because of robustness and simplicity of use, a touch screen provides the most preferred method for user interaction with the jukebox network. Touch screen 26 displays menu buttons and selection information and senses screen touches in active menu button areas to initiate various actions. An auxiliary screen 27 is also coupled to jukebox client 13 for local (i.e., individual user station) display of jukebox videos and/or advertisements. In order to obtain payment for jukebox selections, a payment acceptor 28 coupled to jukebox client 13 accepts currency and/or credit cards for establishing jukebox credits for use by a customer.

To support more complex services such as web browsing, a keyboard 30 and a point-and-click graphical user interface device such as a trackball 31 are coupled to jukebox client 13. A video camera 32 may also be coupled to client 32 for sending video images from the client station to other points within jukebox network 10 or to remote locations via Internet 24.

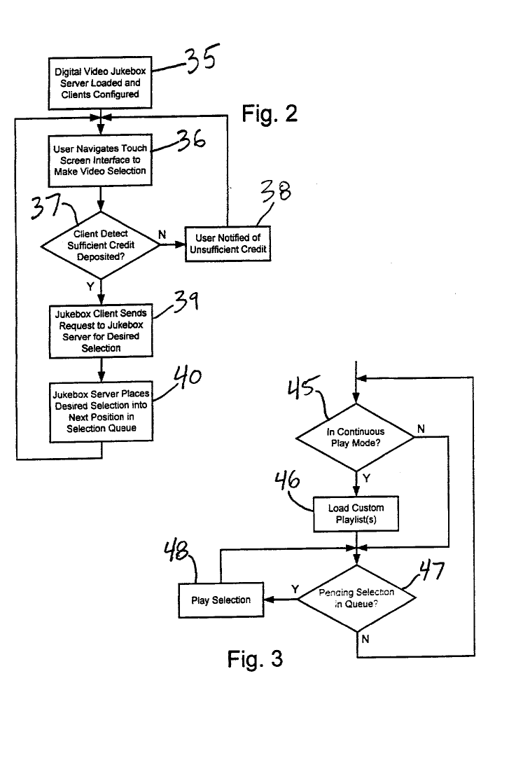

Operation of a preferred embodiment of the present invention is shown in FIG. 2. The digital video jukebox network of the present invention is closely integrated into the commercial enterprise to increase customer satisfaction and lower operating costs. In step 35, the jukebox server is loaded with customized multimedia content selected for the specific commercial enterprise being served. Instead of expensive live DJ's, multimedia content is chosen with the help of the jukebox service provider to match the desired environment to be provided in the premises. A customized set of video and audio files is loaded on the jukebox server, and a filter may be specified if not all of the files in storage are to be available for selection. Default playlists for general or specialized (e.g., theme night) uses may also be loaded. The jukebox clients are configured to provide a user interface matching the multimedia content available from the server.

In step 36, a user navigates a touch screen interface in order to make a video selection. The jukebox client determines in step 37 whether the user has established sufficient credits that are needed (if any) to demand playing of the desired selection. If there is not sufficient credit, then the jukebox notifies the user that there is insufficient credit (e.g., via a message displayed on the touch screen or the auxiliary display) and a return is made to step 36 to allow the user to establish the necessary credits.

If there is sufficient credit, then the jukebox client sends a request in step 39 to the jukebox server to reproduce the desired selection. In step 40, the jukebox server places the identity of the desired selection into the next position of a selection queue that is maintained by the jukebox server. The selection queue can continuously accept additional selections based on user requests from any jukebox clients.

FIG. 3 illustrates one embodiment of a method within the jukebox server for initiating reproduction of video selections. In step 45, the server determines whether it has been commanded to operate in a continuous play mode. If yes, then at least one customized playlist of the customized multimedia content matched to the commercial enterprise is loaded into the server's selection queue in step 46. If not in continuous play mode, then step 46 is skipped. In step 47, a check is made to determine whether there is a selection pending in the selection queue (e.g., a next selection in a customized playlist or a desired selection request from a user). If a pending selection is found, then it is played in step 48 and a return is made to step 47. If there is no pending selection, then a return is made to step 45 to determine whether continuous play mode has been commanded.

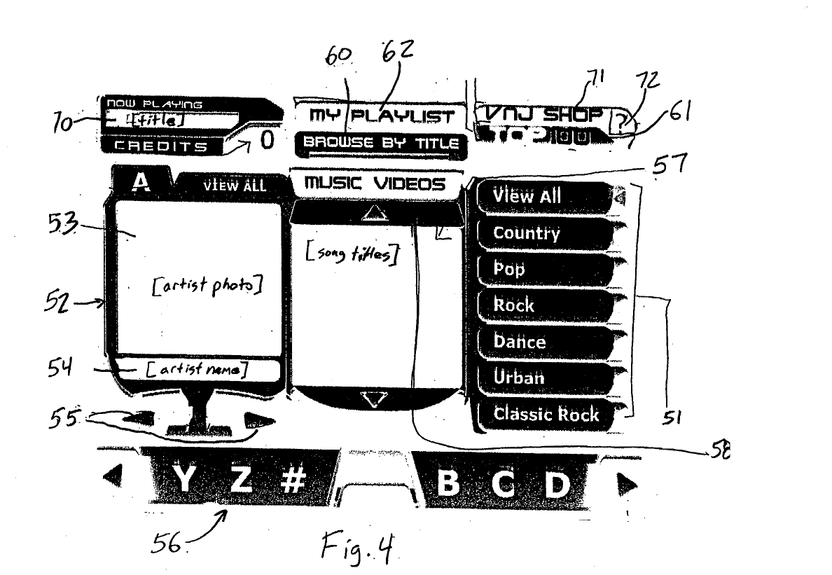

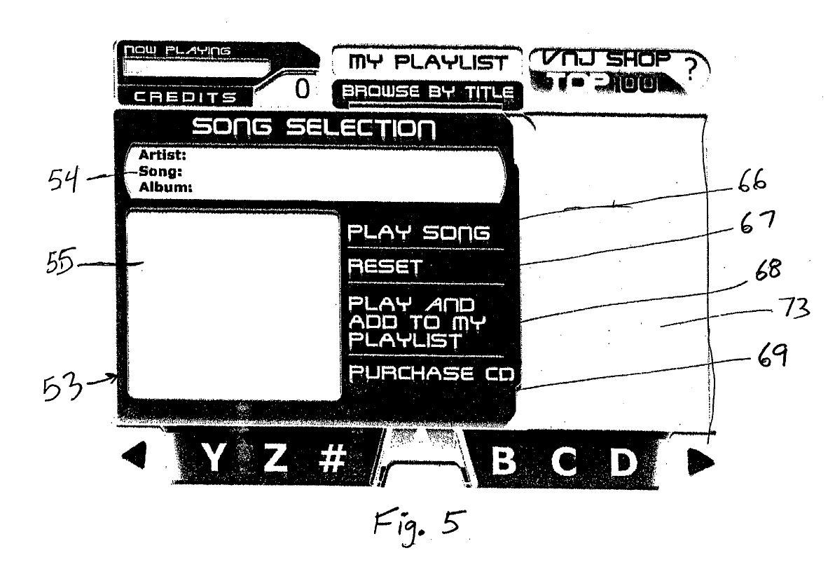

FIG. 4 shows a touch screen user interface wherein a user is able to browse a set of video selections and choose a desired video selection for display by the large-area display system (or by an auxiliary display just for the user and not for the entire premises, if so configured). After a user establishes credits by inserting currency or a credit card into a payment acceptor, the number of established credits is displayed in a credit window 50. The displayed number preferably flashes to emphasize that a desired selection can be entered. Selection may begin with selection of a music genre from a genre bank 51 or may begin with a default genre selection of “View All.” If a genre is selected, then only the song titles or artist names in that category are searched.

The user interface initially defaults to a search for the desired artist name. An artist selection tool 52 includes a picture window 53, a text window 54, and scrolling arrows 55. Arrows 55 may be used to scroll alphabetically through names of artists corresponding to the selected genre which are in the customized set of available selections. The user can jump to names beginning with a particular character using an alphabet bar 56 at the bottom of the touch screen.

For an artist shown in picture window 53 and text window 54, the corresponding song titles that are currently available are shown in a song title window 57. If all the available titles for an artist do not fit in window 57, then the song titles can be scrolled using scrolling arrows 58. When a desired song title is visible, it is touched on the touch screen display in order to select it and to initiate a corresponding request to the jukebox server.

Rather than searching by artist name, searching can be performed by song title by pressing a browse-by-title button 60. All titles or titles by genre then appear in song title window 57. The user can jump to song titles beginning with a particular character using alphabet bar 56.

Browsing of artist names and/or song titles can also be performed by activating a top-100 button 61 which presents a listing of the 100 most frequently played selections from that jukebox client, for example. By providing user identification (e.g., by providing the ability to input a name and a password or determined automatically in response to a credit card used to establish credits), a personal playlist of previously played selections can be retrieved using a my-playlist button 62.

When a song title is pressed, a confirmation window 63 appears as is shown in FIG. 5. A text window 64 shows the artist name, song title, and album name of the chosen selection and a picture window 65 shows a picture of the corresponding CD cover or artist photograph, for example. A button 66 can be activated to request playing of the video/audio selection. If the selection shown is not the desired selection, then a reset button 67 can be activated and the interface returns to the selection screen. In order to play the selection and add it to the personal playlist, then a button 68 is activated.

An integrated CD vending service can be incorporated into the commercial enterprise, such as by providing a CD burner associated with the jukebox server or the jukebox client. If the user has sufficient credits, then he can request purchase of a CD (either an entire album or a single song) by pressing a button 69.

An immediate play button (not shown) can also be provided in order to provide a higher priority for playing a desired selection when incorporating it into the selection queue of the jukebox server (for an extra charge).

An advertisement window 73 within the confirmation window provides a further opportunity to show ads to the user, such as an ad and pricing information for purchasing a CD having the desired selection thereon.

Returning to FIG. 4, a “now playing” window 70 displays the title of a selection being played at the jukebox client station and/or at the large-area display. A “shop” button 71 may be selected to bring up a vending interface for making purchases. A “help” button 72 may be activated in order to receive on-screen help messages.

By providing additional support interfaces as described below and by customization of sets of video/audio selections available, the present invention provides an integrated business solution with a variety of functions and features, including the following.

Entertainment Manager Mode

This mode allows a business establishment to adopt a theme for the entertainment or atmosphere of the premises. For example, the establishment may be a dance club or a sports bar and the customized theme provides video selections according to those themes, such as dance music videos or sports programming, respectively. Themes may be semi-permanent or may be tied to special events or holidays (e.g., ethnic music such as Jamaican music on a tropics night or Irish music on St. Patrick's Day, sports selections during a sports playoff, karaoke video selections on a Karaoke night, or movie selections during special movie events such as the announcement of Oscar Award nominations). The special themes may be implemented without removal or replacement of the multimedia selections stored in connection with the jukebox server by specifying a filter that limits the available selections to those matching the theme.

Digital DJ

The digital DJ mode provides customized playlists of selections within the total multimedia content that is available. The playlists may be organized according to predetermined start times and/or dates as desired by those operating the commercial enterprise. The customized playlists play continuously unless a customer purchases a selection, although any purchased selection can only be chosen from the predetermined, customized set. The digital video jukebox network can be programmed to accept user selections with or without purchased credits, or for insertion into the currently pending selection queue at a priority level commensurate with a payment amount, for example.

Performer Rotation Manager

For nightclubs providing live entertainment by live performers in rotation (e.g., standup comics, professional dancers, singers, etc.), a jukebox client having a live performer interface is provided. If performers are required to pay a fee to the business establishment, then a payment acceptor interacts with the live performer interface to collect the fee. Presented by the live performer interface is a customized set of video selections that may be provided for the type of performance in general or a coordinated playlist for the individual performer can be set up in advance. The set of video selections may include a prerecorded audiovisual announcement for an event or for an individual performer. If the performer is scheduled to appear at specific times, then the announcement can be generated automatically at the designated time.

Time Clock Mode

For establishments with hourly employees, an application is provided for keeping track of hours worked by individual employees. An employee interface is preferably presented via the touch screen so that an employee can select their name to sign in and sign out. The information is collected and reported by the jukebox network to the management of the business establishment.

Cash Register Mode

A user can access a vending interface for browsing a selection of available goods and for choosing a desired good to be purchased from the commercial enterprise. After receiving a corresponding payment via the payment acceptor, the jukebox client transmits a request for the desired good to the jukebox server which interfaces to either manual or automated delivery systems (e.g., a counter clerk or one or several vending machines).

Security System Mode

Using the video camera attached to jukebox clients, live video images of the premises are captured and can be transmitted to security personnel or to business owners/managers locally within the premises or remotely via the Internet connection. A password protected website can be established so that the premises can be remotely viewed by the business owner from anywhere that Internet access is available. The video camera can be provided with remote control for remotely panning a video camera or adjusting a view.

Digital Broadcasting Network Mode

By virtue of the Internet connection, not only can Internet browsing be made available to a user of the jukebox clients, but multipoint digital video broadcasts distributed over the Internet can be received and displayed by the jukebox server. These broadcasts can include pay-per-view events or sporting events. If initiated by a customer, then payment for an event can be obtained from the customer.

Advertising Mode

Via auxiliary displays attached to jukebox clients or the large-area displays attached to the jukebox server, various advertising videos and/or audios are presented to patrons of the business establishment. Upcoming events in the establishment can be advertised, or advertising time can be sold to advertisers wanting to reach the viewer base in the business establishment. The advertisements can be shown interspersed with video selections or in predetermined time slots.

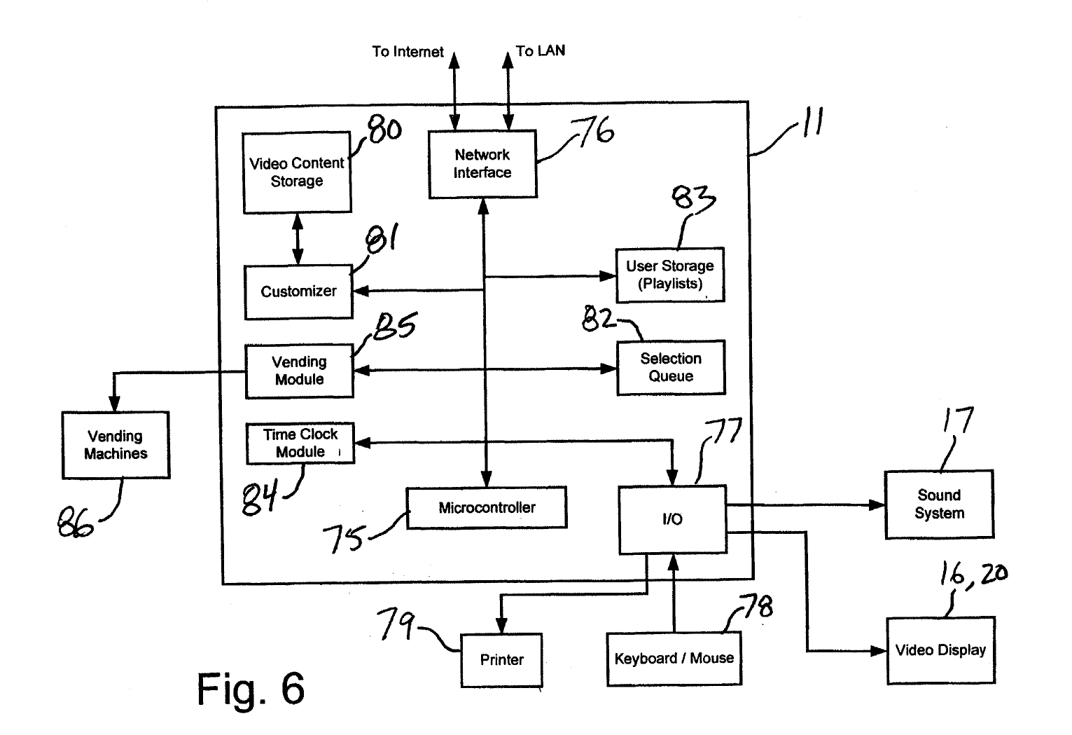

Jukebox server 11 is shown in greater detail in FIG. 6. A main microcontroller (e.g., on a motherboard) is coupled to a network interface 76 to exchange network traffic in a LAN configuration with the jukebox clients and in a WAN configuration with an Internet connection. An input/output (I/O) block 77 interfaces between microcontroller 75 and peripheral devices such as a keyboard and mouse 78, printer 79, sound system 17, and displays 16 and 20. Video content storage 80 includes the removable hard drives mentioned previously for storing the multimedia files. A customizer 81 is programmed to filter predetermined subsets of the files in storage 80 (i.e., limit availability to only those selections within a predetermined theme or DJ-created playlist). Jukebox server 11 includes a selection queue 82 that identifies selections to be played. Frequent users may create personal playlists that are stored in user storage 83.

In connection with the time clock mode of operation, a time clock module 84 maintains employee lists including ID's, passwords, and hours worked.

In connection with the cash register mode, a vending module 85 is provided for controlling the distribution of goods based on interaction with a jukebox client from which a user initiates a purchasing transaction. The client identifies a selected good, verifies sufficient payment, and transmits an authorization to the jukebox server which provides centralized control of vending machines 86, for example. The server or client may alternatively notify a human clerk of a purchase, with the clerk delivering the selected goods.

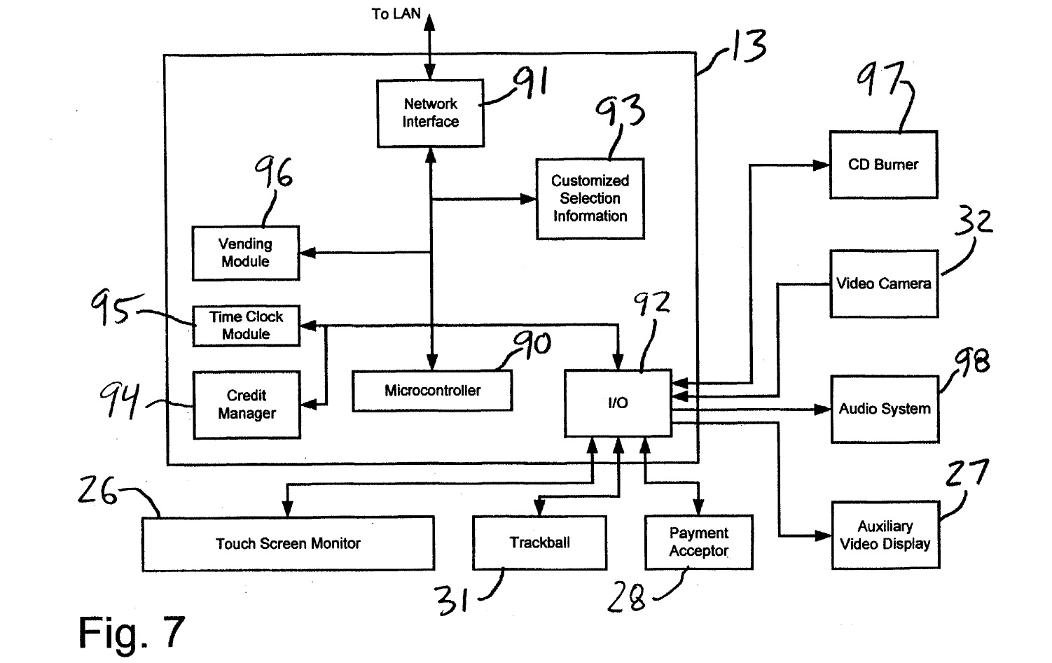

A jukebox client 13 is shown in greater detail in FIG. 7. A main controller 90 is coupled to a network interface 91 and a peripheral I/O interface 92. Customized selection information 93 is used in presenting a user interface on touch screen monitor 26 by defining the functionality of the interface and providing details about the video selections obtained from the jukebox server.

A credit manager module 94 interfaces with payment acceptor 28 for accounting for credits established and used at the jukebox client. For credit card use, a dial-up modem connection may provide credit verification and authorization.

A time clock module 95 can be activated in the time clock mode so that the employee interface is presented on touch screen 26. Module 95 forwards sign in or sign out activity to the time clock module in the jukebox server.

A vending module 96 is provided for generating the vending interface which presents available goods selections to a user, processes payments, and may send purchase authorizations to the jukebox server if goods are not being delivered by the jukebox client itself. One type of goods that may be provided is a recording of a video or audio selection. Thus, a CD burner 97 can be activated by vending module 96 to create a CD of the selection, for delivery to the customer.

In addition to auxiliary display 27, an audio system 98 is coupled to client 13 to reproduce video selections and/or advertisements shown by client 13.

Having described my invention, I claim:

1. An integrated video jukebox and entertainment management system for a premises, comprising:
a video jukebox server providing a set of video selections customized to a predetermined commercial enterprise for said premises;
a large-area display system;
a plurality of jukebox clients deployed in said premises and networked with said jukebox server;
a payment acceptor coupled to at least one of said jukebox clients for establishing credits for accessing said video selections; and
a touch screen input device coupled to said one jukebox client for providing a user interface wherein a user is able to browse said set of video selections and choose a desired video selection for display by said large-area display system, said one jukebox client transmitting a request to said jukebox server for displaying said desired video selection if sufficient credits are established.

2. The system of claim 1 wherein said set of video selections provides a theme for said commercial enterprise.

3. The system of claim 2 wherein said theme is selected from the group consisting of dance, karaoke, ethnic music, movies, and sports.

4. The system of claim 2 wherein said set of video selections comprises prerecorded music videos.

5. The system of claim 2 wherein said set of video selections comprises live broadcast events.

6. The system of claim 1 further comprising a removable hard drive coupled to said jukebox server for storing said set of video selections.

7. The system of claim 1 wherein said jukebox server is coupled to a public data network for accessing at least a portion of said set of video selections.

8. The system of claim I wherein said jukebox server stores a predetermined playlist and sequentially plays selections from said set of video selections according to said playlist.

9. The system of claim 8 wherein a request for a desired video selection transmitted by said jukebox client is inserted into said playlist by said jukebox server.

10. The system of claim 1 wherein said large-area display system is comprised of a projector and a projection screen.

11. The system of claim 1 wherein said large-area display system is comprised of a plurality of television monitors coupled to said jukebox server and deployed within said premises.

12. The system of claim 1 wherein said commercial enterprise includes live entertainment and wherein said touch screen input device further provides a live performer interface for choosing coordinated video selections for accompanying said live entertainment.

13. The system of claim 12 wherein said coordinated video selections include a prerecorded audiovisual introduction for a live performer.

14. The system of claim 12 wherein said jukebox server provides a customized playlist corresponding to said live performer, wherein said live performer interface is adapted to access said customized playlist.

15. The system of claim 12 wherein said jukebox server establishes times for separate live performers and automatically generates prerecorded audiovisual introductions for each live performer.

16. The system of claim 1 wherein said commercial enterprise includes hourly employees and wherein said touch screen input device further provides an employee interface for maintaining a time clock of hours worked.

17. The system of claim 1 further comprising an auxiliary display coupled to said jukebox client for displaying video selections transmitted from said jukebox server.

18. The system of claim 17 wherein said displayed video selections include said desired video selection chosen via said user interface.

19. The system of claim 17 wherein said displayed video selections include prerecorded advertisements transmitted by said jukebox server.

20. The system of claim 1 wherein said touch screen input device further provides a vending interface for browsing a selection of available goods and for choosing a desired good to be purchased from said commercial enterprise, said one jukebox client transmitting a request for said desired good after receiving a corresponding payment via said payment acceptor.

21. The system of claim 1 wherein said payment acceptor is comprised of a currency acceptor.

22. The system of claim 1 wherein said payment acceptor is comprised of a credit card reader.

23. The system of claim 1 further comprising a video camera coupled to said one jukebox client for obtaining security images of said premises and transmitting said images to said jukebox server.

24. The system of claim 23 wherein said jukebox server is coupled to a public data network and wherein said security images are transmitted to said public data network.

25. The system of claim 1 further comprising:
a keyboard coupled to said jukebox client; and
a point-and-click graphical input device coupled to said jukebox client;
wherein said jukebox server is coupled to a public data network and wherein said jukebox client includes a network browser responsive to said keyboard and said point-and-click graphical input device.

26. The system of claim 1 further comprising a plurality of jukebox clients, each coupled to said jukebox server and to a respective touch screen input device.

27. The system of claim 1 further comprising an audio player for manual selection of prerecorded audio selections in the event of a failure of video reproduction.

28. A method of managing a video entertainment system on a premises comprising the steps of:
loading a set of video selections in a video jukebox server, said set of video selections being customized to a predetermined commercial enterprise for said premises;
transmitting selection information corresponding to said set of video selections from said jukebox server to a plurality of jukebox clients within said premises;
displaying a user interface to a user on a touch screen input device coupled to one of said jukebox clients, wherein said user is able to browse said selection information and choose a desired video selection;
said user establishing credits for accessing said video selections using a payment acceptor coupled to said jukebox client;
said one jukebox client transmitting a request to said jukebox server for displaying said desired video selection if sufficient credits are established; and
displaying said desired video selection on a large-area display system visible within said premises.

29. The method of claim 27 further comprising the step of customizing said set of video selections to provide a theme for said commercial enterprise.

30. The method of claim 28 wherein said theme is selected from the group consisting of dance, karaoke, ethnic music, movies, and sports.

31. The method of claim 28 wherein said set of video selections comprises prerecorded music videos.

32. The method of claim 28 wherein said set of video selections comprises live broadcast events.

33. The method of claim 27 further comprising the steps of:
storing a predetermined playlist in said jukebox server; and
sequentially playing selections from said set of video selections according to said predetermined playlist.

34. The method of claim 27 wherein said commercial enterprise includes live entertainment, said method further comprising the step of:
providing a live performer interface on said touch screen input device for choosing coordinated video selections for accompanying said live entertainment.

35. The method of claim 27 wherein said commercial enterprise includes hourly employees, said method further comprising the step of:
providing an employee interface on said touch screen input device for maintaining a time clock of hours worked by said hourly employees.

36. The method of claim 27 further comprising the step of displaying prerecorded advertisements on displays associated with said jukebox clients.
